(19) United States
(12) Patent Application Publication
(10) Pub. No.: US 2019/0164167 A1
(43) Pub. Date: May 30, 2019

(54) System and Method for Identity Verification of a User

(71) Applicant: Walmart Apollo, LLC, Bentonville, AR (US)

(72) Inventor: Kellie Embree, Bentonville, AR (US)

(21) Appl. No.: 16/204,132

(22) Filed: Nov. 29, 2018

Related U.S. Application Data
(60) Provisional application No. 62/592,805, filed on Nov. 30, 2017.

(51) Int. Cl. G06Q 20/40; G06Q 20/32; G06Q 20/20; G06Q 30/06

(52) U.S. Cl. CPC G06Q 20/40145; G06Q 30/0607; G06Q 20/206; G06Q 20/3274

(57) ABSTRACT

An system and a method utilizing a quick response (QR) code to facilitate the transaction of restricted items. The system receives information about a first user from the first user. The system interfaces with systems to determine whether the first user can purchase the restricted items. The system creates a record for the first user and generates a QR code linking the user information to the database record. The system creates a record for a second user, linked to the record for the first user, authorizing the second user to act on behalf of the first user. A second user may utilize the QR code, and identifying information at a point of sale terminal to complete the transaction. Once the transaction is completed, the first user is presented with an indication whether the QR code is still valid.

### RELATED APPLICATIONS

This application claims priority to U.S. Provisional Application No. 62/592,805 filed on Nov. 30, 2017, the content of which is hereby incorporated by reference in its entirety.

### BACKGROUND

The process for identity verification of an agent/surrogate and the principle routinely is informal, variable, and prone to error.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system supporting identity verification according to an exemplary embodiment.

FIG. 2 is a flowchart that illustrates a process of a registering and using a QR code for identification across the actors of an exemplary embodiment.

FIG. 3 is a block diagram illustrating an architecture of a system for supporting identity verification according to an exemplary embodiment.

FIG. 4 is a flowchart illustrating a process of verifying identification of users in a transaction according to an exemplary embodiment.

FIG. 5 is a block diagram illustrating an electronic device for supporting identity verification according to an exemplary embodiment.

### DETAILED DESCRIPTION

Described in detail herein is a system for verifying the identity and authorization of an agent/surrogate to complete a gated action on behalf of a principle. The system utilizes a registration of a first user and a subsequent generation of a QR code identifying the first user's registration information indicative of the first user's ability to complete a gated transaction. The system receives the QR code at a point-of-sale terminal where a first or second user's information is validated, and a gated or restricted transaction can be completed.

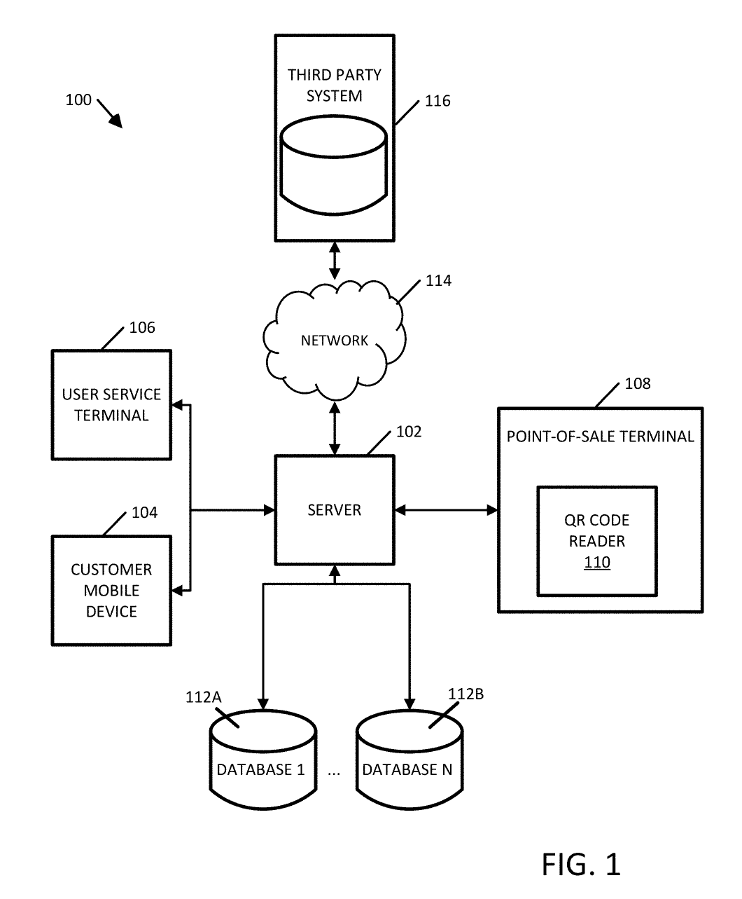

FIG. 1 is a block diagram illustrating a system 100 supporting identity verification according to an exemplary embodiment. The system 100 can include one or more servers 102, user service terminals 106, point-of-sale terminals 108, and databases 112A and 112B.

The server 102 can be programmed to perform actions central to supporting identity verification and can be communicatively connected to external (third party) systems and subsystems 116 via a network 114. The connections can be wireless or wired. Wireless communication can be implemented in standards-based interfaces including WiFi and 4G Long Term Evolution (LTE). Other wireless communication standards can be used in implementation as long as the standards support the higher application layers of the Open Systems Interconnect (OSI) stack necessary to support the purchase management system. Similarly, the server 102 may be connected through wired connections. The wired connections may include any physical medium and underlying OSI stack as to support the higher level application layers to support the purchase management system. The server 102 can generate and issue QR codes for use in the system 100. The QR codes generated by the server 102 can be linked to globally unique identifiers (GUID).

A user mobile device 104 can be in communication with the server via the network to receive, transport, and display QR codes. The user mobile device 104 can be communicatively connected to the server 102 via wireless communications. In some implementations, the wireless communication can be facility provided WiFi, otherwise the communication can be facilitated by cellular carrier connections including 4G LTE. The QR code can be imported onto the user mobile device 104 from the server 102 by an application executing on the device 104. The application can be an instant messaging client, social media application, email application, or special purposed application designed to interact with the system 100. In exemplary embodiments, the application executing on the user mobile device can operate as an extension of the system 100 to facilitate operations and processes of the system in response to actions and/or operations occurring on the user mobile device 104 in response to execution of the application. The user mobile device 104 can be a smart phone handset, a personal digital assistant, a tablet computer, or any other mobile platform capable of receiving and displaying a QR code.

A user service terminal 106 facilitates enrollment into the system 100 and provides a user interface to an associate that allows the associate to input information identifying a first user. The information can include government issued identification information or other verifiable information from which a first user's identity can be verified/authenticated. For example, the information can also include biometrics or images of the first user. The user service terminal 106 can include optical capture devices such as cameras and fingerprint readers to facilitate capture of biometrics and images. Additional biometric identification methods such as iris scanners, facial recognition, and voice recognition may be employed at the user service terminal 106. Additionally the user service terminal 106 can allow an associate to input information identifying a second user related to the first user. The second user can be a spouse, parent, agent, or anyone the first user requires or designates. For age restricted transaction processing, the first and second users each must meet the requirements for completing a transaction associated with a restricted item individually. In one embodiment, the user service terminal 106 communicates through a wired connection to the server 102 for the input and processing of user transactions. The user service terminal 106 can allow the first user to designate a conditions that when met, allow or disallow the second user from completing the transaction. For example, the first user can designate criteria in the form of a time window limitation for the transaction, resulting in a temporary QR code that has an expiration date. Additionally, the conditional enrollment can allow a first user to enroll, and allow the second user to generate a temporary QR code at a later date so long as the conditions established by the first user are met. Alternatively, the user service terminal 106 can be a self service portal, where the first user and second user can enroll with the system 100 without the assistance of an associate.

A point-of-sale terminals 108 can perform and control a transaction on the system 100. The point-of-sale terminals 108 in some implementations can be disposed at checkout stands in a retail environment. Point-of-sale terminals 108 can be equipped with touchscreen user interfaces to facilitate transactions. Point-of-sale terminals 108 can additionally be equipped with cameras for taking digital images of users and products/items. Digital images taken by the point-of-sale terminals 108 can be transmitted to the server 102 via the network 114 for additional processing.

The cameras associated with the point-of-sale terminals 108 can operate as QR code readers 110. The QR code readers 110 can be implemented in image processing hardware at the point-of-sale terminals 108. Alternatively the QR code readers 110 can capture images of QR code at the point-of-sale terminals 108 via the attached cameras, and transmit the images of the QR codes to the server 102 for processing. Additional biometric systems including iris scanners, fingerprint readers, facial recognition systems, and voice recognition systems can be employed to further validate the identity of a user.

The one or more databases 112A, 112B can be in communication with the server and can contain information for identifying, verifying, and/or authenticating the first user and the second user. As described herein, the identifying information can be stored in the database after being input via the user service terminal 106. The databases 112A, 112B can store generated QR codes associated with the first user as well as the associated GUID. The databases 112A, 112B can also store requirements for transaction associated with restricted items including characteristics of the person that must be satisfied before a transaction associated with one or more restricted items can be completed (e.g. minimum age, etc.).

Extending out beyond the internal infrastructure, the network 114 facilitates external communication with additional systems. The network 114 can take the form of the Internet or intranets, and can facilitate communication between the server and the third party system 116 as described herein. The third party system 116 can be a governmental compliance system such as the National Instant Criminal Background Check Service (NICS). The server 102 can utilize application programming interfaces (APIs) provided by the third party system 116 to provide inputs to, and receive outputs from, the third party system 116. For embodiments in which the third party system 116 is the NICS system, the server 102 transmits the user's governmental identification information to the NICS system for verification, and the NICS system responds by transmitting a positive or negative result to the server 104. Based on that result, the server 102 can provide the associate at the user service terminal 106 and indication to deny or complete the QR code registration process.

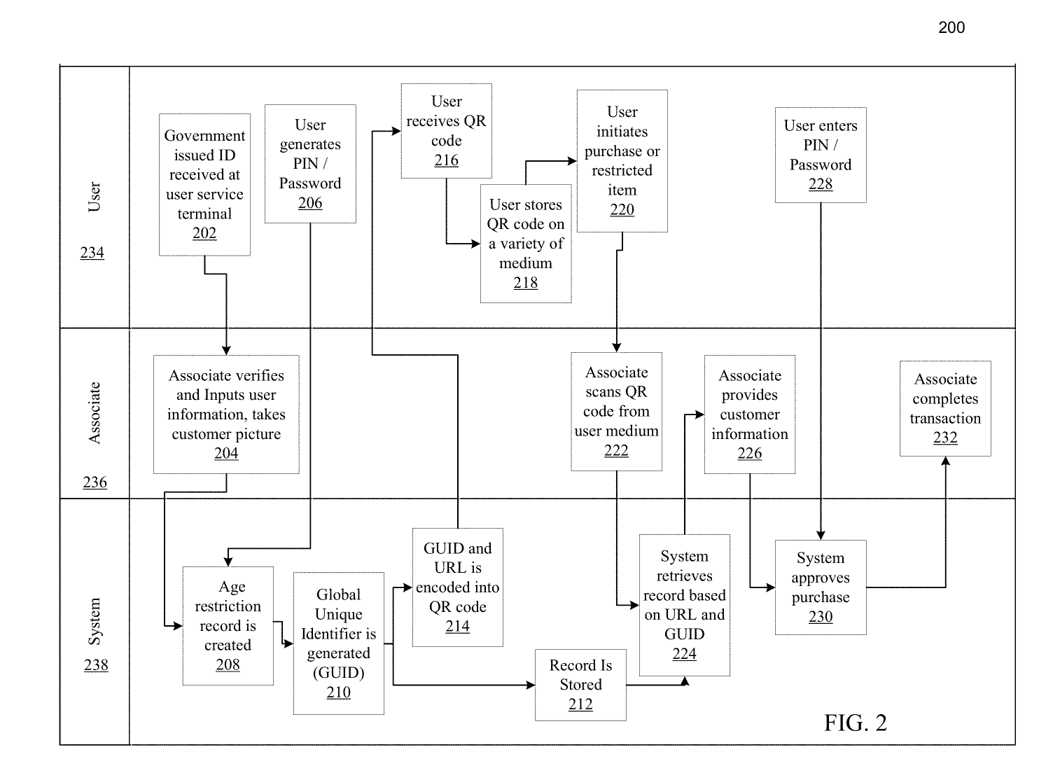

FIG. 2 is a flowchart 200 that illustrates a process for user verification and authentication based registering and using a QR code for identification according to an exemplary embodiment. The actors include a user 234, a registration associate 236, and components of the system 100. The system 100 includes backend automated processes.

At step 202, a government issued identification 234 is received by the at user service terminal 106. In one embodiment, the government issued identification can be a state issued driver's license. In other embodiments the government issued identification can take the form of a military identification card, a passport, a social security card, or a voter identification card. Alternatively, or in addition, the user 234 can present information related to a second user who can pick up the order. The registration information related to the second user can include government identification information from a government issued identification.

At step 204, the user information 236 is verified, input, and a camera associated with the system captures the user's picture 204. The user service terminal 106 receives the user's information obtained from the government issued identification as an input from the registration associate 236. The user's picture can be stored with a record of the registration in the databases 112A or 112B (FIG. 1). If the first user designates a second user, the relevant identification information for the second user can be input to the user service terminal by the registration associate 236 and a picture of the second user can be captured by the camera associated with the system as well. Biometric data of the second user can be captured to further identify the second user and to increase security of the system.

At step 206, the user service terminal receives a personal identification number (PIN) or password that is generated and input to the user service terminal by the user 234. The PIN or password is unique to the user 234 and the registration. In one embodiment, the PIN or password can expire after a predetermined passage of time. Alternatively, the PIN or password can remain valid indefinitely or until the user 234 changes either.

At step 208, a restriction record is created in the databases 112A and/or 112B (FIG. 1). The restriction record can be created at the server 102. The restriction record can contain or be linked to the user information obtained from the government issued identification. Additionally, the password or PIN generated at step 206 can be linked to the restriction record.

At step 210, the server 102 generates a Global Unique Identifier (GUID). The GUID is generated to identify the restriction record in the system 238. The GUID can be linked to the restriction record or alternatively, the GUID can be added to the restriction record.

At step 212, the server stores the restriction record in the databases 112A, 112B. The age restriction record can include the GUID as well as the PIN or password. Alternatively, the GUID and the PIN or password can be stored in separate databases 112A, 112B, and linked to the restriction record using a stored identifier indicative of the database record entry corresponding to the GUID and the PIN or password.

At step 214 the GUID and universal resource locator (URL) is encoded into a QR code at the server 102. The GUID and the URL identify the specific restriction record and as well as its location in memory.

At step 216, an instance of the QR code is transferred to a device associated with the user 234 by the server. In one embodiment the QR code can be delivered electronically. The delivery can be implemented through an email client, social media posting, instant messaging client or a specialized merchant application capable of facilitating the electronic transfer of the QR code.

At step 218, the QR code can be stored on a variety of medium. For example, the QR code can be stored on the user mobile device 104. The user mobile device 104 can store the QR code locally in a nonvolatile memory space and/or can store the QR code in a cloud synchronized memory space remote from the user mobile device, where the QR code can be available to more than one computing devices under the user's control. Additionally, the user 234 can print the QR code on a piece of paper to provide to a second user.

At step 220, a transaction including a restricted item can be initiated. Alternatively, the transaction including the restricted item can be initiated by the second user on behalf of the user 234. The initiation can take place at a point-of-sale terminal 108.

At step 222, a QR code reader 110 at the point-of-sale terminal 108 scans the QR code from user medium (e.g., under the control of the associate 236). The QR code, as described herein, can be presented from the user mobile device 104 or from a piece of paper.

At step 224, the server 102 of the system 100 retrieves a record based on URL and GUID. The server 102 accesses the databases 112A, 112B and accesses the restriction record corresponding to the URL and GUID. The server 102 returns user information for the associate 236 to verify.

At step 226, the customer information is verified. The system receives input from the associate 236 and compares it against the customer information previously provided. The verification can include image processing to identify unique features in the input received images of the user 234. Additional information relating to the user commonly found on government issued identification can be compared to validate customer information. Additionally, the associate 236 via the point-of-sale terminal 108 has discretion to verify other user information, however, because of the presentation of the QR code, the associate 236 recognizes that the user's information has been verified. Alternatively, the associate 236 can verify the information of a second user acting on behalf of the user 234.

At step 228, the user 234 enters PIN or password. The PIN or password provides a two factor authentication in conjunction with the scanned QR code, that the user 234 has been properly verified. Alternatively, the PIN or password can be entered by the second user acting on behalf of the user 234, thereby confirming the relationship between the user 234 and the second user and verifying/authenticating the identity of the second user.

At step 230, the system 238 approves the transaction including the restricted item. The system 238 validates that the PIN or password is correct in conjunction with the associated QR code.

At step 232, the transaction including the restricted item is completed. For example, upon receipt of approval from the system 238, the transaction is complete by releasing any restricted items included in the transaction to the user 234 or the second user acting on behalf of the user 234.

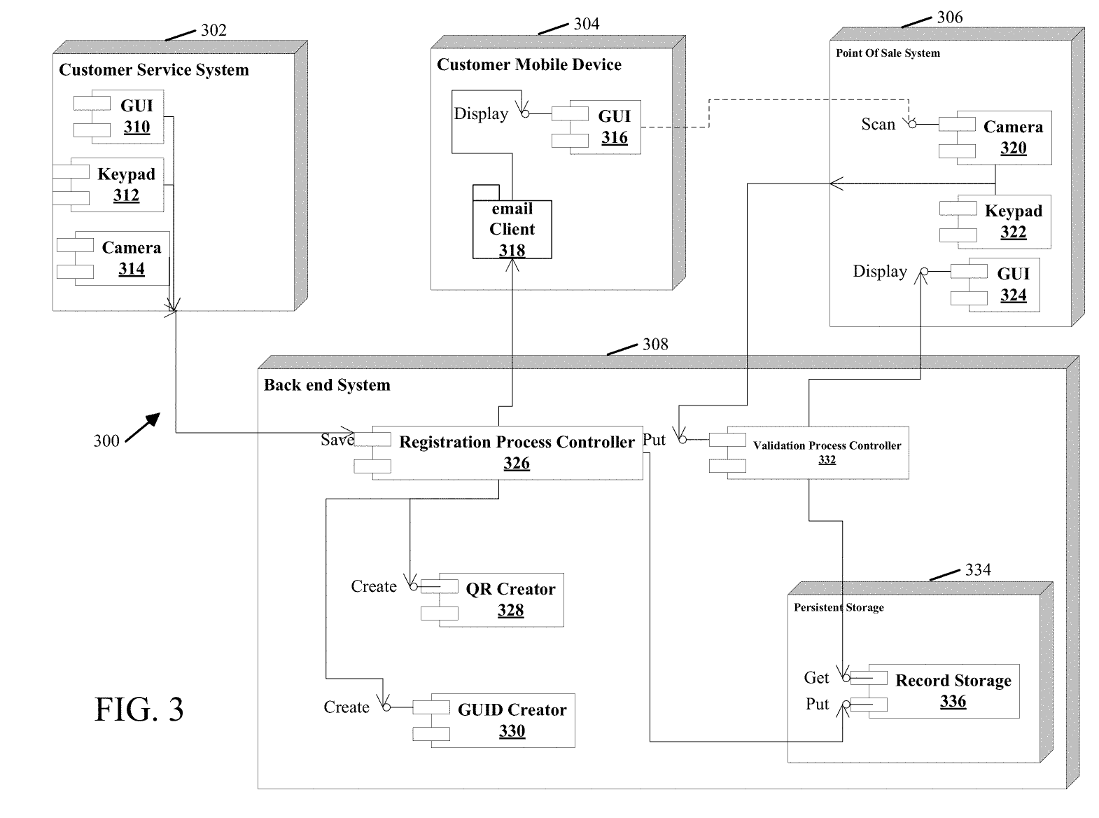

FIG. 3 is a block diagram illustrating an architecture 300 of a system for supporting identity verification according to an exemplary embodiment.

As shown in FIG. 3, the architecture 300 can be hosted across physical components of an embodiment of the system 100 shown in FIG. 1. The logical distribution of functionality can be implemented in any software development language or combination of languages operable to execute on the physical components in FIG. 1. In one embodiment, the implementation of the logical distribution is a function of inputs and outputs from each of the modules, regardless of the underlying software stack. For example, the back end system 308 may be executing as a service, implemented in C++, on a Linux operating system, and the user mobile device 304 may be implemented as an Java application executing a Google Android operating system, where the implementations are different and only coupled by their ability to provide proper inputs and outputs to the respective components.

A user service system 302 can be implemented in a user service terminal 106. The user service system 302 functionally provides a graphical user interface (GUI) 310, a keypad 312, which may be virtual or physical, and a camera 314. The GUI 310 can provide an associate with prompts for information relevant to entering user information. The prompts can include data fields corresponding to fields present on government issued identification. Additionally the GUI 310 can provide prompts for the associate to enter the second user's information from their respective government issued identification and link it to the user's information. The keypad 312 provides the input functionality for the associate to enter information into the GUI 310. The keypad 312 can be a physical device attached to the user service terminal 106 or alternatively the keypad 213 can be a virtual device implemented in the GUI 310 itself.

A user mobile device 304 provides the user with a connection into the system. The user mobile device 304 provides a GUI 316 for the user. Also executing on the user mobile device is an email client 318. The email client 318 can be a third party application equipped to accept incoming email protocol connections from the back end system 308. Alternatively, the email client 318 can be implemented as a instant messaging client, a social media application, or a specialized application for the receipt of QR codes. The GUI 316 provides functionality for the viewing of any received QR codes consistent with the display necessary to be read by a QR code reader.

A point of sale system 306 provides the functionality for utilization of a QR code to finalize a transaction. The point of sale system 306, like the user service system 302, includes a GUI 324, keypad 322, and a camera 320. The GUI 324 provides an interface for the user to interact with the system. The keypad 322 provides one method of interaction with the system. Like the user service system 302, the keypad 322 at the point of sale system 306 can be implemented physically or virtually in the GUI 324. The keypad 322 allows the user in utilize the GUI 324 to complete the transaction of the product. The keypad 322 in conjunction with the GUI 324 can facilitate the user input of a PIN or password. The camera 320 provides functionality for imaging the QR code received at the user mobile device 304. The camera 320 is operable to detect and image a QR code displayed on the screen of a user mobile device 304. Additionally the camera 320 is operable to detect and image a printed QR code.

The back end system 308 can be hosted on the server 102. The back end system 208 logically allocates functionality appropriate to execute on the server 102 into an architecture of modules with well-defined inputs and outputs. The back end system 308 provides the needed infrastructure to link the QR code with the user information to support the purchase. The entry point into the back end system 308 is the registration process controller 326. The registration process controller 326 receives the user information from the user service system 302. The registration process controller 326 creates a record for the user information. Alternatively, the registration process controller 326 creates are linked record for a second user's information, if a second user will be retrieving the product on behalf of the user. The registration process controller 326 instructs the GUID creator 330 to create a GUID for the record for the user information Likewise the registration process controller 326 provides the generated GUID from the GUID creator 330 to the QR creator 328 to encode and create a QR code linking to the user record. The registration process controller 326 can update the user record to include a timestamp corresponding to an expiration of the QR code, indicating that it is no longer a valid for the transaction.

The registration process controller 326 transmits the resultant encoded and linked QR code to the user mobile device 304. The QR code is received by the email client 318, or other appropriate application for receiving QR codes including instant messaging clients, social media clients, and specialize applications for receiving QR codes.

The registration process controller 326 provides the resultant user record to a persistent storage 334 device. The persistent storage 334 can be implemented in the for of databases 112A, 112B. The actual storage of the record can be abstracted from the registration process controller 326 by the persistent storage 334. The record is stored by the record storage 336. The record storage 336 defines the interface for setting and retrieving any record stored on the persistent storage 334 device. The persistent storage 334 can provide an interface to index into a database containing first user information, multiple biometric data entries corresponding to the first user information, and compare the biometric data entries to validate the first user. The persistent storage 334 can provide flags or fields to identify entries in invalid states. For example, if a temporary QR code expires, the persistent storage 334 processes an event notification to update the entry corresponding to the temporary QR code and mark it as invalid.

The validation process controller 332 provides the interface into the back end system 308 for the completion of the transaction. The validation process controller 332 retrieves imaged QR codes from the camera 320 on the point of sale system 306. The validation process controller 332 decodes the QR code, and looks up the identified user record in the persistent storage 334. The validation process controller 332 validates that the expiration date for the user information is still valid, and then passes a positive or negative response to the GUI 324 of the point of sale system 306. In the event of a positive response, allowing the transaction to complete, the validation process controller 332 can additionally provide the user or the second user acting on behalf of the user, an indication of remaining time until the expiration of the QR code.

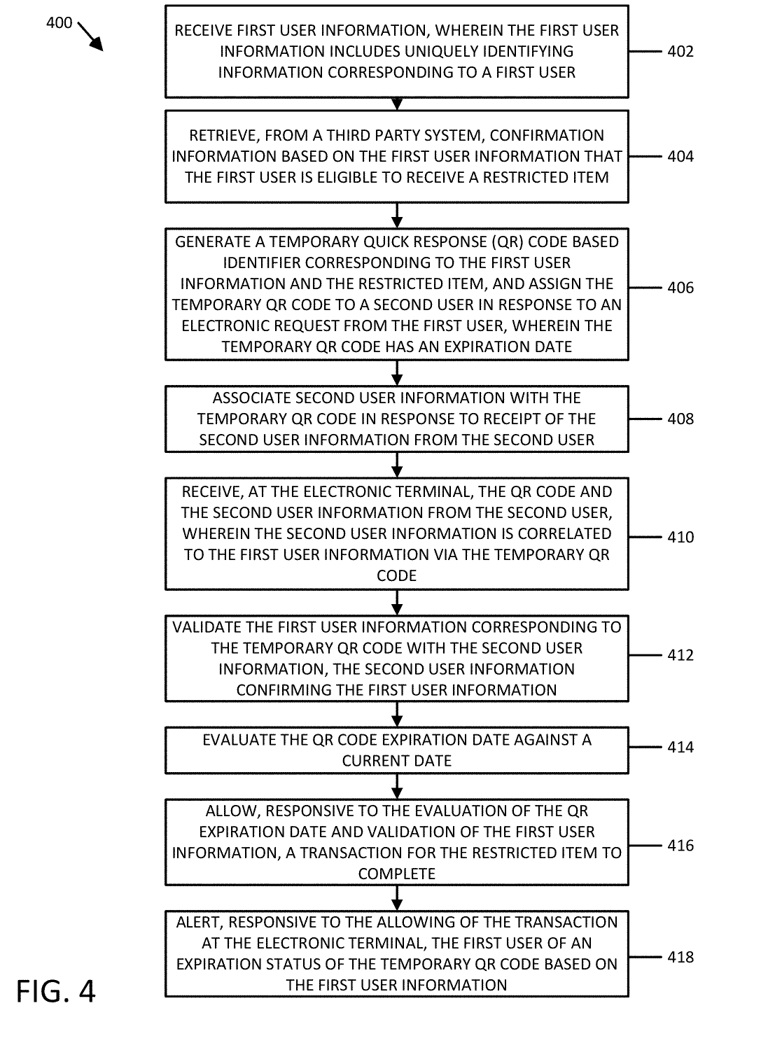

FIG. 4 is a flowchart illustrating a process 400 utilizing a QR code for identification in a purchase according to an exemplary embodiment. The process 400 can be implemented on an embodiment of the system 100 illustrated in FIG. 1 and an embodiment of the architecture illustrated in FIG. 3.

At step 402, first user information is received by the user service terminal and input into one or more databases by a server in communication with the user service terminal. The first user information includes uniquely identifying information corresponding to a first user. In one embodiment, the user service terminal 106 provides the input device for uniquely identifying information. In one embodiment, the first user can be a user attempting to purchase a restricted item.

At step 404, the server can retrieve confirmation information from a third party system based on the first user information that the first user is eligible to receive a restricted item. The third party system can verify a first user's identity and whether the first user can receive a restricted item such as medications. The confirmation information can include an indication that the first user, based on the provided information, is eligible to purchase and receive the restricted item. As described above, the third party system 116 may include governmental compliance systems.

At step 406, a temporary quick response (QR) code based identifier corresponding to the first user information and the restricted item is generated by the server, and the temporary QR code is assigned to a second user by the server in response to an electronic request from the first user. The temporary QR code has an expiration date. As described above, the registration process controller 326 receives input from the user service system 302 and generates a QR code with an expiration date.

At step 408, second user information is associated with the temporary QR code by the server in response to receipt of the second user information from the second user. The registration process controller 326 assigns the received second user information pertaining to a second user authorized to act on behalf of the first user to the record corresponding to the first user.

At step 410, the QR code and the second user information is received at the electronic terminal from the second user. An electric terminal can take the form of a but isn't limited to a point of sale terminal 108. The second user information can be correlated to the first user information via the temporary QR code. The point of sale system 306 receives the scanned QR code provided by the second user.

At step 412, the back end system 308 validates the first user information corresponding to the temporary QR code with the second user information, where the second user information confirms the first user information. When the second user attempts to complete the transaction, the validation process controller 332, validates that the second user information is linked to the first user information.

At step 414, the back end system 308 evaluates the QR code expiration date against a current date. The validation process controller 332 compares the expiration date associated with the record to the time associated with the current transaction.

At step 416, a transaction for the restricted item is allowed to complete by the point-of-sale terminal responsive to the evaluation of the QR code expiration date and validation of the first user information. If the expiration date is still valid, the transaction is completed.

At step 418, the point of sale terminal 108 alerts, responsive to the allowing of the transaction at the electronic terminal, the first user of an expiration status of the temporary QR code based on the first user information. At the conclusion of the transaction the validation process controller 332 may update the record in record storage 336, to indicate that the QR code has been used. The registration process controller 326 can receive an event notification indicating the record has been updated, and provide to the email client 318 an indication that the QR code is still valid, and provide the expiration date.

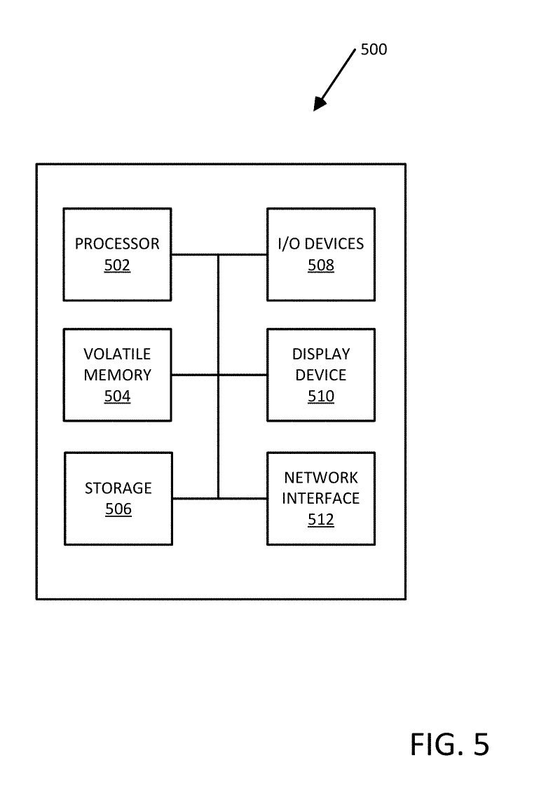

FIG. 5 is a block diagram illustrating a computing device 500 for supporting identity verification according to an exemplary embodiment.

The computing device 500 includes one or more non-transitory computer-readable media for storing one or more computer-executable instructions or software for implementing exemplary embodiments described herein. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 504 included in the computing device 500 can store computer-readable and computer-executable instructions or software for implementing exemplary operations of the computing device 500. The computing device 500 also includes configurable and/or programmable processor 502 for executing computer-readable and computer-executable instructions or software stored in the volatile memory 504 and other programs for implementing exemplary embodiments of the present disclosure. Processor 502 can be a single core processor or a multiple core processor. Processor 502 can be configured to execute one or more of the instructions described in connection with computing device 500.

Volatile memory 504 can include a computer system memory or random access memory, such as DRAM, SRAM, EDO RAM, and the like. Volatile memory 504 can include other types of memory as well, or combinations thereof.

A user can interact with the computing device 500 through a display 510, such as a computer monitor, which can display one or more graphical user interfaces supplemented by I/O devices 508, which can include a multi-touch interface, a pointing device, an image capturing device and a reader.

The computing device 500 can also include storage 506, such as a hard-drive, CD-ROM, or other computer-readable media, for storing data and computer-readable instructions and/or software that implement exemplary embodiments of the present disclosure (e.g., applications). For example, storage 506 can include one or more storage mechanisms for storing information associated with viewed and ultimately bought scores and latent attributes and can be indexed accordingly. The storage mechanism can be updated manually or automatically at any suitable time to add, delete, and/or update one or more data items in the databases 112A, 112B.

The computing device 500 can include a network interface 512 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 512 can include one or more antennas to facilitate wireless communication between the computing device 500 and a network and/or between the computing device 500 and other computing devices. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system for the verification of identity for restricted items comprising:
a server communicatively coupled to a third party system;
an electronic terminal communicatively coupled to the server; and
a registration module configured to execute on the server, wherein the registration module is configured to:
receive first user information, wherein the first user information comprises uniquely identifying information corresponding to a first user,
retrieve, from the third party system, confirmation information based on the first user information that the first user is eligible to receive a restricted item;
generate a temporary quick response (QR) code based identifier corresponding to the first user information and the restricted item, and assign the temporary QR code to a second user in response to an electronic request from the first user, wherein the temporary QR code has an expiration date;
associate second user information with the temporary QR code in response to receipt of the second user information from the second user;
receive, at the electronic terminal, the QR code and the second user information from the second user, wherein the second user information is correlated to the first user information via the temporary QR code;
validate the first user information corresponding to the temporary QR code with the second user information, the second user information confirming the first user information;
evaluate the QR code expiration date against a current date;
allow, responsive to the evaluation of the QR expiration date and validation of the first user information, a transaction for the restricted item to complete; and
alert, responsive to the allowing of the transaction at the electronic terminal, the first user of an expiration status of the temporary QR code based on the first user information.

2. The system of claim 1, wherein the first user information comprises a user name, a user address, and a government-issued identification number corresponding to the first user.

3. The system of claim 2, wherein the second user information comprises a first biometric data entry corresponding to the second user.

4. The system of claim 3, wherein the server, executing the registration module, is configured to:
index into a database containing the first user information,
retrieve a second biometric data entry corresponding to the first user information, and
compare the first and second biometric data entry to validate the first user information.

5. The system of claim 1, wherein the first user information is stored in a database until the QR code expiration date.

6. The system of claim 1, wherein the first user information persists in an invalid state in a database after the QR code expiration date.

7. The system of claim 1, wherein the electronic terminal includes an iris scanner, fingerprint reader, facial recognition, and voice recognition.

8. A method for the verification of identity for restricted item comprising:
receiving first user information, wherein the first user information comprises uniquely identifying information corresponding to a first user,
retrieving, from a third party system, confirmation information based on the first user information that the first user is eligible to receive a restricted item;
generating a temporary quick response (QR) code based identifier corresponding to the first user information and the restricted item, and assign the temporary QR code to a second user in response to an electronic request from the first user, wherein the temporary QR code has an expiration date;
associating second user information with the temporary QR code in response to receipt of the second user information from the second user;
receiving, at the electronic terminal, the QR code and the second user information from the second user, wherein the second user information is correlated to the first user information via the temporary QR code;
validating the first user information corresponding to the temporary QR code with the second user information, the second user information confirming the first user information;
evaluating the QR code expiration date against a current date;
allowing, responsive to the evaluation of the QR expiration date and validation of the first user information, a transaction for the restricted item to complete; and
alerting, responsive to the allowing of the transaction at the electronic terminal, the first user of an expiration status of the temporary QR code based on the first user information.

9. The method of claim 8, wherein the first user information comprises user name, user address, and a government-issued identification number corresponding to the first user.

10. The method of claim 9, wherein the second user information comprises a first biometric data entry corresponding to the second user.

11. The method of claim 10, the validating further comprises:
indexing into the a database containing the first user information,
retrieving a second biometric data entry corresponding to the first user information, and
comparing the first and second biometric data entry.

12. The method of claim 8, wherein the first user information is stored in a database until the QR code expiration date.

13. The method of claim 8, wherein the first user information persists in an invalid state in a database after the QR code expiration date.

14. The method of claim 8, wherein the electronic terminal includes an iris scanner, fingerprint reader, facial recognition, and voice recognition.

15. A non-transitory computer readable medium, having stored thereon, instructions that when executed by a computing device, cause the computing device to perform operations comprising:
receive a first user information, wherein the first user information comprises uniquely identifying information corresponding to a first user,
retrieve, from a third party system, confirmation information based on the first user information that the first user is eligible to purchase a restricted item;
generate a quick response (QR) code based identifier corresponding to the first user information, wherein the QR code has an expiration date;
receive, from the point of sale terminal, the QR code and a second user information wherein the second user information correlates with the first user information;
validate the first user information corresponding to the received QR code with the second user information where the second user information confirms the first user information;
evaluate the QR code expiration date against a current date;
allow, responsive to the evaluation of the QR expiration date, a transaction for the restricted item to complete; and
alert, responsive to the allowing of the transaction at the point of sale terminal, the user of an expiration status of the QR code based on the first user information.

16. The computer readable medium of claim 15, wherein the first user information comprises user name, user address, and a government-issued identification number corresponding to the first user.

17. The computer readable medium of claim 16, wherein the second user information comprises a first biometric data entry corresponding to the second user.

18. The computer readable medium of claim 17, wherein the registration module is further configured to:
index into the third party system based on the first user information,
retrieve a second biometric data entry corresponding to the first user information, and
compare the first and second biometric data entry.

19. The computer readable medium of claim 15, wherein the first user information is stored in a database until the QR code expiration date.

20. The computer readable medium of claim 15, wherein the first user information persists in an invalid state in a database after the QR code expiration date.
